(19) United States
(12) Patent Application Publication
(10) Pub. No.: US 2009/0017296 A1
(43) Pub. Date: Jan. 15, 2009

(54) Pressure-Sensitive Adhesive Sheet for Automobile Marking

(75) Inventors: Tadahiro Tomino, Tokyo (JP); Atsuhiro Tanaka, Tokyo (JP); Kiichiro Kato, Tokyo (JP)

Correspondence Address: POSZ LAW GROUP, PLC, 12040 SOUTH LAKES DRIVE, SUITE 101, RESTON, VA, 20191, US

(73) Assignee: LINTEC CORPORATION, TOKYO (JP)

(21) Appl. No.: 12/223,598

(22) PCT Filed: Jan. 29, 2007
(86) PCT No.: PCT/JP2007/051374

§ 371 Date: Aug. 26, 2008

(30) Foreign Application Priority Data
Feb. 14, 2006 (JP) 2006-037021

(51) Int. Cl. C09J 7/00

(52) U.S. Cl. 428/343

(57) ABSTRACT

A pressure-sensitive adhesive sheet for automobile marking comprising a substrate 11 and a pressure-sensitive adhesive layer 12, wherein the substrate 11 has a storage elastic modulus at 60 to 80° C. of 7.0×10¹ MPa or more, and preferably a storage elastic modulus at 5 to 10° C. of 1.0×10² to 1.0×10³ MPa. As a result there can be obtained a pressure-sensitive adhesive sheet for automobile marking that allows preventing blistering even when used at high temperatures of about 60 to 80° C., without restrictions regarding a pressure-sensitive adhesive composition, and with no need for a primer to be applied to an adherend.

### TECHNICAL FIELD

The present invention relates to a pressure-sensitive adhesive sheet for automobile marking that is used in door sashes in automobiles or the like.

### BACKGROUND

Pressure-sensitive adhesive sheets for automobile marking, for instance door sash tapes as paint-replacing tapes or the like, have come to be extensively used in the exterior of automobiles. During the manufacturing process of an automobile, such pressure-sensitive adhesive sheets for automobile marking may sometimes be stuck to the body, at a temperature of about 60° C., or may be heated to about 80° C. after sticking to the body. The temperature of the body having stuck thereon the pressure-sensitive adhesive sheet for automobile marking may also rise to about 80° C., for instance in the summer.

Conventional pressure-sensitive adhesive sheets for automobile marking, however, are problematic in that when used under such high-temperature conditions, they give rise to blistering, which mars outer appearance. Such blistering is believed to be caused by expansion, on account of heating, of air trapped in small irregularities on the adhesive surface of the pressure-sensitive adhesive sheet, or on the painted surface of the automobile, as the adherend.

To tackle the above problems there have been proposed, for instance, an invention for preventing peeling and blistering of a marking film, by using a specific pressure-sensitive adhesive component (Patent document 1), and an invention for preventing peeling or the like of a pressure-sensitive adhesive sheet, by coating an adherend with a specific primer (Patent document 2).

[Patent document 1] Japanese Patent Application Laid-open No. H05-78626

[Patent document 2] Japanese Patent Application Laid-open No. 2003-138206

### DISCLOSURE OF THE INVENTION

### Problem to be Solved by the Invention

In the invention described in Patent document 1, however, the problem of blistering fails to be solved when the marking film is used at high temperatures. Also, the invention requires a specific pressure-sensitive adhesive composition, which restricts thus the desired adhesive characteristics that can be obtained. Meanwhile, the invention described in Patent document 2 requires an extra primer to be coated on the adherend, as well as an extra primer coating operation.

In light of the above, it is an object of the present invention to provide a pressure-sensitive adhesive sheet for automobile marking that allows preventing blistering even at high temperatures of about 60 to 80° C., without restrictions regarding a pressure-sensitive adhesive composition, and with no need for a primer to be applied to an adherend.

### Means for Solving the Problem

To attain the above object, the present invention provides a pressure-sensitive adhesive sheet for automobile marking, comprising a substrate and a pressure-sensitive adhesive layer, wherein the storage elastic modulus at 60 to 80° C. of the substrate is 7.0×10¹ MPa or more (Invention 1).

Note that in the present description, “sheet” is deemed to include the idea of a film, and “film” is deemed to include the idea of a sheet.

According to the above invention (Invention 1), the substrate exhibits certain rigidity at 60 to 80° C., and hence the substrate of the pressure-sensitive adhesive sheet is not influenced by the expansion, through heating, of air trapped in small irregularities of the pressure-sensitive adhesive surface of the pressure-sensitive adhesive sheet, or of air trapped in small irregularities of the coating surface of the automobile as the adherend. This prevents blistering of the pressure-sensitive adhesive sheet, thereby maintaining the good appearance of the pressure-sensitive adhesive sheet.

In the above invention (Invention 1), preferably, the storage elastic modulus at 5 to 10° C. of the substrate is 1.0×10² to 1.0×10³ MPa (Invention 2). The substrate having such a storage elastic modulus imparts excellent stickability to the pressure-sensitive adhesive sheet, even at low temperatures of about 5 to 10° C.

The pressure-sensitive adhesive sheet according to the above inventions (Inventions 1, 2), is preferably stuck to an adherend the temperature of which is 60 to 80° C. (Invention 3). The pressure-sensitive adhesive sheet according to the above inventions (Inventions 1 to 3) is preferably stuck to an adherend the temperature of which becomes 60 to 80° C. after sticking (Invention 4).

The pressure-sensitive adhesive sheet for automobile marking of the present invention affords a distinctive blistering preventing effect, in particular when used under the above-described conditions.

### ADVANTAGEOUS EFFECT OF THE INVENTION

The pressure-sensitive adhesive sheet for automobile marking of the present invention allows preventing blistering, without restrictions regarding a pressure-sensitive adhesive composition, and with no need for a primer to be applied to an adherend, even when stuck to a body that is at a high temperature of 60 to 80° C., or when the temperature is raised to 60 to 80° C. after sticking to the body.

### BRIEF DESCRIPTION OF THE DRAWINGS

FIG. 1 is a sectional view of a pressure-sensitive adhesive sheet for automobile marking according to an embodiment of the present invention; and

FIG. 2 is a side view of a pressure-sensitive adhesive sheet and an adherend, for illustrating a stickability test method.

1 . . . pressure-sensitive adhesive sheet
11 . . . substrate
12 . . . pressure-sensitive adhesive layer
13 . . . release liner
2 . . . adherend

### BEST MODE FOR CARRYING OUT THE INVENTION

Embodiments of the present invention are explained below.

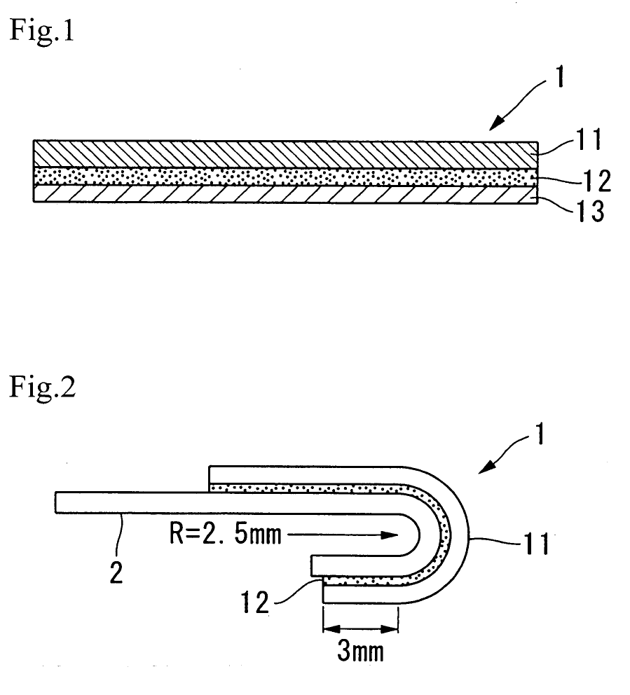

FIG. 1 is a sectional view of a pressure-sensitive adhesive sheet for automobile marking according to an embodiment of the present invention.

As shown in FIG. 1, a pressure-sensitive adhesive sheet for automobile marking 1 (hereinafter, also “pressure-sensitive adhesive sheet 1” for short) according to the present embodiment comprises a substrate 11, a pressure-sensitive adhesive layer 12 and a release liner 13 laminated on one another. Note, however, that the release liner 13 is peeled off when using the pressure-sensitive adhesive sheet 1.

The substrate 11 must have a storage elastic modulus at 60 to 80° C. of 7.0×10¹ MPa or more, preferably a storage elastic modulus of 8.0×10¹ to 1.0×10⁴ MPa, and more preferably of 1.0×10² to 8.0×10² MPa. The substrate 11 having such a storage elastic modulus exhibits certain rigidity at 60 to 80° C. As a result, the substrate 11 of the pressure-sensitive adhesive sheet 1 is not influenced by expansion of air trapped in the small irregularities on the pressure-sensitive adhesive surface (surface of the pressure-sensitive adhesive layer 12 opposite the substrate 11) of the pressure-sensitive adhesive sheet 1, or on the surface of the adherend, when, for instance, the pressure-sensitive adhesive sheet 1 is stuck to an adherend at a temperature of 60 to 80° C., or when the temperature is raised to 60 to 80° C. after sticking the pressure-sensitive adhesive sheet 1 to the adherend. This prevents blistering of the pressure-sensitive adhesive sheet 1, thereby maintaining the good appearance of the pressure-sensitive adhesive sheet 1.

The storage elastic modulus at 5 to 10° C. of the substrate 11 is preferably 1.0×10² to 1.0×10³ MPa, in particular 2.0×10² to 9.0×10² MPa. The substrate 11 having such a storage elastic modulus exhibits certain flexibility even at low temperatures of about 5 to 10° C. As a result, the pressure-sensitive adhesive sheet 1 has excellent stickability.

The material of the substrate 11 is not particularly limited, so long as it satisfies the above storage elastic modulus. The material ordinarily used herein is a resin film or a laminate having a resin film as a base material.

Examples of a resin film include, for instance, films or a foamed film made of a resin such as polyethylene, polypropylene or other polyolefin, a polyester such as polyethylene terephthalate or polybutylene terephthalate, polyvinyl chloride, polystyrene, a polyurethane, a polycarbonate, a polyamide, a polyimide, polymethylmethacrylate, polybutene, polybutadiene, polymethylpentene, an ethylene-vinyl acetate copolymers, an ethylene-(meth)acrylic acid copolymers, an ethylene-(meth)acrylate copolymers, an ABS resin, an ionomer resin; or a thermoplastic elastomer containing a component such as a polyolefin, a polyurethane, polystyrene, polyvinyl chloride, a polyester or the like, or a laminated film of the above. Preferred herein are films comprising a polyurethane, a polyester thermoplastic elastomer, or a polyolefin thermoplastic elastomer. The resin film may comprise various additives, such as inorganic fillers, organic fillers, UV absorbers or the like.

A laminate having the resin film as a base material may be obtained, for instance, by superposing a coating layer onto one or both faces of the resin film. Examples of the coating layer that can be superposed onto one side of the resin film (front face of the substrate 11) include, for instance, a colored or decorative layer provided through printing, painting, applying on paint, transfer from a transfer sheet, vapor deposition, sputtering or the like, an undercoat layer such as an easy-adhesive coat for forming such a decorative layer, a gloss adjustment coat or the like, or a topcoat layer such as a hard coat, an antifouling coat, a weather-proof coat, a surface roughness or specular gloss adjusting coat, as well as an antistatic layer or the like. These coat layers may be formed over the whole surface of the resin film, or may be formed on only part surface of the resin film.

Examples of the coating layer superposed onto the other side of the resin film (side of the substrate 11 in contact with the pressure-sensitive adhesive layer 12) include, for instance, a primer layer for enhancing stickability to the pressure-sensitive adhesive layer 12, an antistatic layer or the like.

The thickness of the coating layer is generally approximately from 0.1 to 50 μm, preferably from 1 to 10 μm, but can be appropriately changed in accordance with the type of coating layer or the use of the pressure-sensitive adhesive sheet 1.

The thickness of the substrate 11 is generally approximately from 10 to 400 μm, preferably from 30 to 200 μm, but can be appropriately changed in accordance with the material of the substrate 11 or the use of the pressure-sensitive adhesive sheet 1.

Examples of the pressure-sensitive adhesive constituting the pressure-sensitive adhesive layer 12 include, for instance, an acrylic type pressure-sensitive adhesive, a polyester type pressure-sensitive adhesive, a polyurethane type pressure-sensitive adhesive, a rubber type pressure-sensitive adhesive, a silicone type pressure-sensitive adhesive or the like. In terms of stickability to the painted surface of an automobile, an acrylic type pressure-sensitive adhesive, in particular an acrylic type pressure-sensitive adhesive containing an epoxy type or isocyanate type cross-linking agent, are preferred among the above pressure-sensitive adhesive. Moreover, the pressure-sensitive adhesive may be of an emulsion type, a solvent type or a solventless type, but is preferably of a solvent type in the case of an acrylic type pressure-sensitive adhesive.

The thickness of the pressure-sensitive adhesive layer 12 is generally approximately from 1 to 300 μm, preferably from 5 to 100 μm, but can be appropriately changed in accordance with the use of the pressure-sensitive adhesive sheet 1.

The material of the release liner 13 is not particularly limited. As such a material there may be used a film or a foamed film made of a resin such as polyethylene terephthalate, polypropylene, polyethylene or the like, or paper such as glassine, coated paper, laminated paper or the like that has been subjected to release treatment with a release agent such as a silicone one, a fluorine type one, or a long chain alkyl group-containing carbamate.

The thickness of the release liner 13 is generally approximately from 10 to 250 μm, preferably from 20 to 200 μm.

When the pressure-sensitive adhesive sheet 1 is subjected to punching processing, it is preferable to use a release paper of thickness from 130 to 200 μm obtained by subjecting a laminated paper, laminated with polyethylene, to a release treatment with a silicone type release agent.

The pressure-sensitive adhesive sheet 1 may be produced in accordance with ordinary methods. For instance, the pressure-sensitive adhesive layer 12 may be formed on the release-treated surface of the release liner 13, followed by superposing the substrate 11 onto the surface of the pressure-sensitive adhesive layer 12. The pressure-sensitive adhesive layer 12 can be formed by preparing a coating agent that contains the pressure-sensitive adhesive agent constituted the pressure-sensitive adhesive layer 12, and also a solvent if desired, applying the coating agent onto the release-treated surface of the release line 13 using a coater such as a roll coater, a knife coater, a roll-knife coater, a die coater, a bar coater, a gravure coater, a curtain coater or the like, and drying.

The pressure-sensitive adhesive sheet 1 explained above is stuck, as a pressure-sensitive adhesive sheet for automobile marking, onto the exterior (body) of an automobile, for instance onto a door sash or the like. The pressure-sensitive adhesive sheet 1 does not blister, and maintains a good appearance, even when stuck to the body at a temperature of about 60° C., when heated to about 80° C. after sticking to the body, or when the temperature of the body having stuck thereon the pressure-sensitive adhesive sheet 1 rises to about 80° C., for instance in the summer.

The pressure-sensitive adhesive sheet 1 according to the present embodiment comprises the release liner 13, but the present invention is not limited thereto, and the release liner 13 may be omitted. Also, the size, shape and so forth of the pressure-sensitive adhesive sheet 1 according to the present embodiment are not particularly limited in any way. For instance, the pressure-sensitive adhesive sheet 1 may be a tape-like sheet (pressure-sensitive adhesive tape) comprising only the substrate 11 and the pressure-sensitive adhesive layer 12, wound up in the shape of a roll.

### EXAMPLES

Following is a more detailed description of the present invention through examples and so on; however, the scope of the present invention is not limited by those examples and so on.

### Example 1

A solvent-type acrylic pressure-sensitive adhesive agent (made by Lintec, SK) comprising an epoxy type cross-linking agent was applied using a knife coater such that the thickness after drying would be 40 μm onto the release-treated surface of a release liner (made by Oji Paper Co., Ltd., SP-12HL, thickness: 170 μm,) obtained by subjecting a polyethylene laminated paper with a silicone type release agent, and drying was carried out for 1 minute at 90° C. A 100 μm-thick polyurethane film (made by Nippon Carbide Industries Co., Inc., B65-G20) as a substrate was pressed onto the pressure-sensitive adhesive layer thus formed, whereby a pressure-sensitive adhesive sheet was obtained.

### Example 2

A pressure-sensitive adhesive sheet was produced in the same way as in Example 1, except that herein a 100 μm-thick polyester type thermoplastic elastomer film (made by Kurabo Industries, Ltd., ES-9460) was used as the substrate.

### Example 3

A pressure-sensitive adhesive sheet was produced in the same way as in Example 1, except that herein a polyolefin type thermoplastic elastomer film (made by Mitsubishi Chemical MKV Co., Artply CT032, thickness: 100 μm), having a 2 μm-thick weather-proof colored coating layer on its surface, was used as the substrate, and the pressure-sensitive adhesive layer was pressed onto the opposite face of the weather-proof colored coating layer.

### Comparative Example 1

A pressure-sensitive adhesive sheet was produced as in Example 1, except that herein a 100 μm-thick polyvinyl chloride film (made by Kyowa Leather Cloth Co., Ltd., KBO-G30-950100) was used as the substrate.

### Test Example

The storage elastic modulus of the substrates used in the examples and comparative example was measured as follows. The results are shown in Table 1.

Measurement of storage elastic modulus: The substrates were cut to a 3 mm×30 mm size, and then the storage elastic modulus was measured at 5° C., 10° C., 60° C. and 80° C., at a frequency of 11 Hz, using a dynamic viscoelastometer (Rheovibron DDV-II-EP, by Orientec Corporation). The temperature rise rate was 3° C./minute.

Two blistering tests and a stickability test, as described below, were performed on the pressure-sensitive adhesive sheets obtained in the examples and comparative example. The results are shown in Table 1.

Blistering test (1): A 70 mm×150 mm glass plate (thickness 3 mm) and a 70 mm×150 mm melamine coated plate, as adherends, were placed and left to stand in a thermostatic chamber at 60° C. for 30 minutes. The adherends were removed from the thermostatic chamber and, immediately thereupon, a piece of the pressure-sensitive adhesive sheet cut to a 30 mm×130 mm size (with the release paper peeled off) was stuck to adherends bypassing a 2 kg roller to and fro once. The presence or absence of blistering in the pressure-sensitive adhesive sheet was then verified.

Blistering test (2): Apiece of the pressure-sensitive adhesive sheet cut to a 30 mm×130 mm size (with the release paper peeled off) was stuck onto a 70 mm×150 mm glass plate (thickness 3 mm) and a 70 mm×150 mm melamine coated plate, by passing a 2 kg roller to and fro once, in an environment at 23° C. and 50% RH. The obtained specimens were placed in a thermostatic chamber at 80° C., 5 minutes after sticking of the pressure-sensitive adhesive sheet. The specimens were removed 10 minutes after being placed in the thermostatic chamber, whereupon the presence or absence of blistering was verified.

Stickability test: A melamine coated plate having the width of 50 mm, the length of 150 mm and the thickness of 0.2 mm, was bent back 180°, with R=2.5, to yield an adherend 2, as shown in FIG. 2. In an atmosphere at 5° C. or 10° C. and 50% RH, a piece of the pressure-sensitive adhesive sheet 1 cut to a width of 25 mm and a length of 50 mm (with the release paper peeled off) was stuck onto the adherend 2 by passing a 2 kg roller to and for once so that 3 mm straight portion of the pressure-sensitive adhesive sheet 1 was bent back on the reverse side of the adherend 2, as shown in FIG. 2. The presence or absence of lifting in the bent-back portion after 24 hours from sticking was then verified.

TABLE 1

| | 60° C. | | 80° C. | | 5° C. | | 10° C. | |
|---|---|---|---|---|---|---|---|---|
| | Storage | | Storage | | Storage | | Storage | |
| | elastic | | elastic | | elastic | | elastic | |
| | modulus | Blistering | modulus | Blistering | modulus | Stickability | modulus | Stickability |
| | (MPa) | test (1) | (MPa) | test (2) | (MPa) | test | (MPa) | test |
| Ex. 1 | 2.1 × 10² | No | 1.3 × 10² | No | 6.7 × 10² | No lifting | 6.3 × 10² | No lifting |
| | | blistering | | blistering | | | | |
| Ex. 2 | 2.7 × 10² | No | 1.8 × 10² | No | 8.0 × 10² | No lifting | 7.4 × 10² | No lifting |
| | | blistering | | blistering | | | | |
| Ex. 3 | 2.6 × 10² | No | 1.1 × 10² | No | 8.6 × 10² | No lifting | 7.3 × 10² | No lifting |
| | | blistering | | blistering | | | | |
| Comp. | 5.9 × 10¹ | Blistering | 1.7 × 10¹ | Blistering | 2.1 × 10³ | Lifting | 1.9 × 10³ | Lifting |
| ex. 1 | | | | | | | | |

As can be seen from Table 1, the pressure-sensitive adhesive sheets obtained in the examples exhibited no blistering even when used at a high temperature of 60 to 80° C., while boasting good stickability at a low temperature of 5 to 10° C., both when the adherend was a glass plate and a melamine coated plate.

### INDUSTRIAL APPLICABILITY

The pressure-sensitive adhesive sheet for automobile marking of the present invention is particularly useful when used at a high temperature of 60 to 80° C.

1. A pressure-sensitive adhesive sheet for automobile marking, comprising a substrate and a pressure-sensitive adhesive layer,
wherein the storage elastic modulus at 60 to 80° C. of said substrate is 7.0×10¹ MPa or more.

2. The pressure-sensitive adhesive sheet for automobile marking according to claim 1, wherein the storage elastic modulus at 5 to 10° C. of said substrate is 1.0×10² to 1.0×10³ MPa.

3. The pressure-sensitive adhesive sheet for automobile marking according to claim 1, wherein the adhesive layer is stuck to an adherend the temperature of which is 60 to 80° C.

4. The pressure-sensitive adhesive sheet for automobile marking according to claim 1, wherein the adhesive layer is stuck to an adherend the temperature of which becomes 60 to 80° C. after sticking.
